(19) United States
(12) Patent Application Publication
(10) Pub. No.: US 2020/0116112 A1
(43) Pub. Date: Apr. 16, 2020

(54) AIRFLOW MODIFIER DEVICE FOR A MULTI-THROTTLE INTAKE AIR SYSTEM OF AN INTERNAL COMBUSTION ENGINE

(71) Applicant: GM GLOBAL TECHNOLOGY OPERATIONS LLC, Detroit, MI (US)

(72) Inventor: Charles F. Maguire, III, Metamora, MI (US)

(21) Appl. No.: 16/157,434

(22) Filed: Oct. 11, 2018

(51) Int. Cl. F02M 35/10; F02B 75/22; F02M 35/116

(52) U.S. Cl. CPC F02M 35/10032; F02B 75/22; F02M 35/10091; F02M 35/116; F02M 35/10386

(57) ABSTRACT

An airflow modifier device for reducing air velocity fluctuations in a multi-throttle internal combustion engine. The device includes: first and second air input ports for receiving respective first and second airflows outputted from respective first and second throttles; first and second air output ports for providing air from one or both of the airflows to manifold input ports of a pair of intake air manifolds; and first and second passageways respectively connecting the first air input port with the first air output port and the second air input port with the second air output port. The airflow modifier device further includes a central passageway interconnecting the first and second passageways so that air entering the first and second air input ports can move between the first and second passageways and can thereby reduce air flow velocity fluctuations at flow sensors located in the airflows upstream of the airflow modifier device.

### INTRODUCTION

The present invention relates to techniques for reducing air velocity fluctuations at mass air flow sensors in a multi-throttle internal combustion engine.

Mass air flow (MAF) sensors are used in internal combustion engines to determine the mass of air passing through the throttle and into the air intake manifold for distribution to the cylinders of the engine. Using this air mass data, the engine controller is able to determine the appropriate amount of fuel to deliver to each cylinder for the desired engine power performance and emissions control.

In a multi-throttle engine having two banks of engine cylinders, such as a V-8 engine having two banks for four cylinders each, separate throttles are used for each bank with separate MAF sensors being used to detect the amount of air flowing through each throttle. To reduce air velocity and pressure variations at the MAF sensor, a honeycomb or other screen is often inserted in the airflow path at the MAF sensor to smooth out or straighten the air velocity and pressure fluctuations. However, these flow screens create a restriction that may undesirably reduce airflow to the intake manifold.

### SUMMARY

According to one aspect of the invention, there is provided an airflow modifier device for reducing air velocity fluctuations in a multi-throttle internal combustion engine. The airflow modifier device includes:
first and second air input ports for receiving respective first and second airflows outputted from respective first and second throttles;
first and second air output ports for providing air from one or both of the airflows to manifold input ports of a pair of intake air manifolds; and
first and second passageways respectively connecting the first air input port with the first air output port and the second air input port with the second air output port;
wherein the airflow modifier device further includes a central passageway interconnecting the first and second passageways so that, when in use, air entering the first and second air input ports can move between the first and second passageways and can thereby reduce air flow velocity fluctuations at flow sensors located in the airflows upstream of the airflow modifier device.

According to various embodiments, the airflow modifier device may further include any one of the following features or any technically-feasible combination of some or all of these features:
the airflow modifier device comprises an integral or unitary body that defines the passageways, wherein the first air input port and first air output port each comprise tubular extensions of the body that are aligned with each other so as to form the first passageway centered along a first flowpath line extending through the airflow modifier device through center points of the first air input port and first air output port, and wherein the second air input port and second air output port each comprise tubular extensions of the body that are aligned with each other so as to form the second passageway centered along a second flowpath line extending through the airflow modifier device through center points of the second air input port and second air output port;
the body further comprises a lateral plenum that connects the tubular extensions defining the first passageway with the tubular extensions defining the second passageway, the lateral plenum being open into the first and second passageways and defining the central passageway that interconnects the first and second passageways;
the first and second flowpath lines are linear and extend in a direction parallel to each other, and wherein the central passageway extends along a linear third flowpath line that is perpendicular to the first and second flowpath lines;
the first and second passageways each have a cross-sectional area A that are equal to each other, and the central passageway has a cross-sectional area B that is at least 50% and not more than 150% of the cross-sectional area A.

According to another aspect of the invention, there is provided a multi-throttle intake air system for an internal combustion engine. The intake air system includes:
first and second throttles each having a throttle input port, a throttle output port, a passageway connecting the throttle input port and throttle output port, and a throttle control member that controls the magnitude of an airflow through the passageway of its associated throttle;
first and second air intake manifolds each having a manifold input port and a plurality of manifold output ports, wherein the manifold input port of the first air intake manifold receives air exiting the throttle output port of the first throttle, and the manifold input port of the second air intake manifold receives air exiting the throttle output port of the second throttle; and
an airflow modifier device having first and second air input ports, first and second air output ports, and first and second passageways respectively connecting the first air input port with the first air output port and the second air input port with the second air output port, wherein the airflow modifier device further includes a central passageway interconnecting the first and second passageways so that air entering the first and second air input ports can move between the first and second passageways;
wherein the airflow modifier device is located upstream of the intake manifolds such that air entering the intake manifolds is conveyed to the manifold input ports via at least one of the passageways of the airflow modifier device.

According to various embodiments, the intake air system of the preceding paragraph may further include any one of the following features or any technically-feasible combination of some or all of these features:
the intake air system further comprises:
   first and second intake air ducts each having a duct input port, a duct output port, and a passageway connecting the input port and output port, wherein the passageways of the first and second intake air ducts each conveys at least some of the airflow passing through the first and second throttles, respectively; and
   first and second air flow sensors mounted at the first and second intake air ducts, respectively, wherein the first and second air flow sensors measure the airflows moving through the passageways of the respective first and second intake air ducts;
   wherein the airflow modifier device is located between the intake air ducts and the intake manifolds such that air exiting the duct output ports is conveyed to the manifold input ports via at least one of the passageways of the airflow modifier device;
the airflow modifier device is located between the throttles and intake manifolds such that air exiting the throttle output ports is conveyed to the manifold input ports via at least one of the passageways of the airflow modifier device, and wherein the throttle input ports receive the airflows from the duct output ports of the first and second intake air ducts, whereby the intake air ducts and air flow sensors are positioned upstream of the throttles;
during at least some portions of cycles of the internal combustion engine, some of the air entering each of the manifold input ports of the first and second air intake manifolds comes from the airflows passing through the passageways of both the first and second throttles;
the airflow modifier device comprises an integral or unitary body that defines the passageways, wherein the first air input port and first air output port each comprise tubular extensions of the body that are aligned with each other so as to form the first passageway centered along a first flowpath line extending through the airflow modifier device through center points of the first air input port and first air output port, and wherein the second air input port and second air output port each comprise tubular extensions of the body that are aligned with each other so as to form the second passageway centered along a second flowpath line extending through the airflow modifier device through center points of the second air input port and second air output port;
the body further comprises a lateral plenum that connects the tubular extensions defining the first passageway with the tubular extensions defining the second passageway, the lateral plenum being open into the first and second passageways and defining the central passageway that interconnects the first and second passageways;
the first and second flowpath lines are linear and extend in a direction parallel to each other, and wherein the central passageway extends along a linear third flowpath line that is perpendicular to the first and second flowpath lines;
the first and second passageways each have a cross-sectional area A that are equal to each other, and the central passageway has a cross-sectional area B that is at least 50% and not more than 150% of the cross-sectional area A.

According to another aspect of the invention, there is provided a multi-throttle internal combustion engine that includes:
first and second intake air ducts each having a duct input port, a duct output port, and a passageway connecting the input port and output port, wherein the intake air ducts each receives an airflow that enters the input port and exits the output port;
first and second mass air flow sensors mounted at the first and second intake air ducts, respectively, wherein the first and second mass air flow sensors measure the amount of air moving through the passageways of the respective first and second intake air ducts;
first and second throttles each having a throttle input port that receives the airflow exiting from the output port of its associated intake air duct, wherein the first and second throttles each further have a throttle output port, a passageway connecting the throttle input port and throttle output port, and a throttle control member that controls the magnitude of the airflow through the passageway of its associated throttle;
first and second air intake manifolds each having a manifold input port and a plurality of manifold output ports, wherein the manifold input port of the first air intake manifold receives air exiting the throttle output port of the first throttle, and the manifold input port of the second air intake manifold receives air exiting the throttle output port of the second throttle;
first and second cylinder banks each having a plurality of cylinders that, in operation, provide motive power during successive cycles of the internal combustion engine, wherein each of the cylinders of the first cylinder bank are connected to receive air from one of the manifold output ports of the first air intake manifold, and each of the cylinders of the second cylinder bank are connected to receive air from one of the manifold output ports of the second air intake manifold; and
an airflow modifier device having first and second air input ports, first and second air output ports, and first and second passageways respectively connecting the first air input port with the first air output port and the second air input port with the second air output port, wherein the airflow modifier device further includes a central passageway interconnecting the first and second passageways so that air entering the first and second air input ports can move between the first and second passageways;
wherein the airflow modifier device is located between the intake air ducts and the intake manifolds such that air exiting the duct output ports is conveyed to the manifold input ports via at least one of the passageways of the airflow modifier device; and
wherein during at least some portions of the cycles of the internal combustion engine, some of the air entering each of the manifold input ports of the first and second air intake manifolds comes from the airflows passing through the passageways of both the first and second throttles.

According to various embodiments, the multi-throttle internal combustion engine of the preceding paragraph may further include any one of the following features or any technically-feasible combination of some or all of these features:
the airflow modifier device is located between the throttles and intake manifolds such that air exiting the throttle output ports is conveyed to the manifold input ports via at least one of the passageways of the airflow modifier device;
the airflow modifier device comprises an integral or unitary body that defines the passageways, wherein the first air input port and first air output port each comprise tubular extensions of the body that are aligned with each other so as to form the first passageway centered along a first flowpath line extending through the airflow modifier device through center points of the first air input port and first air output port, and wherein the second air input port and second air output port each comprise tubular extensions of the body that are aligned with each other so as to form the second passageway centered along a second flowpath line extending through the airflow modifier device through center points of the second air input port and second air output port;
the body further comprises a lateral plenum that connects the tubular extensions defining the first passageway with the tubular extensions defining the second passageway, the lateral plenum being open into the first and second passageways and defining the central passageway that interconnects the first and second passageways;
the first and second flowpath lines are linear and extend in a direction parallel to each other, and wherein the central passageway extends along a linear third flowpath line that is perpendicular to the first and second flowpath lines;
the first and second passageways each have a cross-sectional area A that are equal to each other, and the central passageway has a cross-sectional area B that is at least 50% and not more than 150% of the cross-sectional area A.

### BRIEF DESCRIPTION OF THE DRAWINGS

One or more embodiments of the invention will hereinafter be described in conjunction with the appended drawings, wherein like designations denote like elements, and wherein:

FIG. 1 is a diagrammatic view of a multi-throttle internal combustion engine having an airflow modifier device constructed in accordance with an embodiment of the invention;

FIG. 2 is a perspective view of the airflow modifier device depicted in FIG. 1;

FIG. 3 is a cross-sectional view of the airflow modifier device of FIG. 2 taken along the horizontal midsection plane identified by the line in FIG. 2;

FIG. 4 is a cross-sectional view of the airflow modifier device of FIG. 2 taken along the vertical midsection plane identified by the IV-IV line in FIG. 2;

FIG. 5 is a top view of the airflow modifier device of FIG. 2; and

FIG. 6 is a graph depicted simulated results of the changes in airflow velocity with and without the air modifier device of FIG. 2.

### DETAILED DESCRIPTION

Described below and shown in the accompanying drawings is an embodiment of an airflow modifier device, a multi-throttle air intake system that incorporates the air modifier device, and an internal combustion engine that includes the multi-throttle air intake system. In general, the airflow modifier device provides a cross-over communication channel or passageway that permits at least partial mixing of the separate intake airstreams being supplied to separate cylinder banks of the engine. This cross-over communication between the airflows permits movement of air between the two intake airstreams in response to differential pressures in the airstreams, thereby enabling those pressure differences to be reduced and thereby reducing the associated velocity fluctuations.

There are a number of advantages to achieving these reduced velocity and pressure fluctuations during engine cycles, including improving the usability of the data received from the intake airflow sensors in the engine without the use of flow screens and, in at least some embodiments, permitting the use of simpler airflow sensors, simpler airflow sensor signal filtering, elimination of flow screens, and more options for sensor placement in the intake air system.

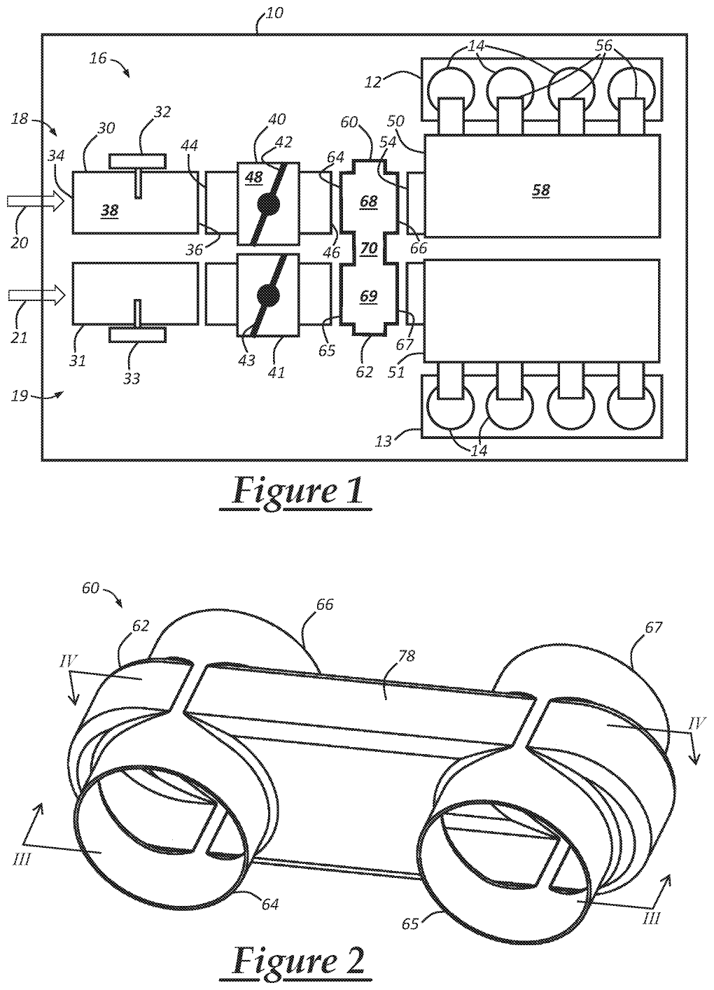

Referring to FIG. 1, there is shown a diagram of a multi-throttle internal combustion engine 10. In particular, depicted is an eight cylinder (e.g., V-8) engine comprising two cylinder banks 12, 13 of four cylinders 14 each. These cylinders, in operation, provide motive power during successive cycles of the internal combustion engine 10. Only the parts of the engine 10 relevant to the invention are shown; the remaining components of the complete engine 10 may be implemented conventionally and are therefore not separately illustrated or described.

The engine 10 includes a multi-throttle intake air system 16 that includes first and second air intake channels 18, 19 that receive respective first and second airflows 20, 21. Each channel 18, 19 includes, respectively, an intake air duct 30, 31, an airflow sensor 32, 33, a throttle 40, 41, and an air intake manifold 50, 51. The intake air system 16 further includes an airflow modifier device 60 which forms a portion of both air intake channels 18, 19 and that is located between the throttles 40, 41 and their respective intake manifolds 50, 51. In general, the airflows 20, 21 enter their associated intake air duct 30, 31, flow past the respective sensors 32, 33, into their associated throttles 40, 41, through the airflow modifier device 60, and into their associated air intake manifolds 50, 51 where they are passed to different ones of the cylinders 14 at different points in the engine cycle. For this, each of the cylinders 14 of the first cylinder bank 12 are connected to receive air from one of the manifold output ports of the first air intake manifold 50, and each of the cylinders 14 of the second cylinder bank 13 are connected to receive air from one of the manifold output ports of the second air intake manifold 51.

The airflow sensors may be mass air flow (MAF) sensors that measure the amount of air moving through the passageways of the respective first and second intake air ducts 30, 31. In other embodiments, other types of mass, velocity, or other suitable airflow sensors may be used.

The volumetric flow through each throttle 40, 41 is controlled by respective throttle control members 42, 43 in accordance with various inputs including, in particular, the driver torque demand as determined by accelerator pedal position. The construction and operation of the throttles 40, 41 and their control members 42, 43 may be conventional and will be known to those skilled in the art.

In the description that follows, the details of only the components of first air intake channel 18 are identified and described, and the construction and operation of the second air intake channel 19 may be identical or at least similar to that of air intake channel 18. In FIG. 1, the first and second air intake channels 18, 19 are shown in exploded view (i.e., with the illustrated airflow components disconnected from each other) so as to separately depict the input and output ports of those components. It will be understood that, as installed, these components would be joined together with airtight connections by hoses, clamps, press-fits, connectors, etc., as suitable for a particular engine so that the airflows 20, 21 are confined to flow only through the components and into that air intake manifolds 50, 51.

For the first air intake channel 18, each of the illustrated airflow components 30, 40, 50, 60 has an input port, output port, and passageway connecting the input and output ports in fluidic communication so that the airstreams can flow through them to deliver air to the engine cylinders 14. In particular, intake air duct 30 includes a duct input port 34, a duct output port 36, and a duct passageway 38 connecting the input port 34 and output port 36 so that air flowing into the input port 34 exits the output port 36. Throttle 40 likewise has a throttle input port 44, a throttle output port 46, and a throttle passageway 48. The throttle input port 44 receives the airflow exiting from the output port 36 of its associated intake air duct 30 and that air moving through the passageway 48 then exits the throttle output port 46. Downstream of the throttle 40 is the air intake manifold 50 which has an input port 54 and a plurality of output ports 56 all connected by a common plenum 58. The manifold input port 54 of the air intake manifold 50 receives air exiting the throttle output port 46 of the throttle 40. In the illustrated embodiment, this is done via the airflow modifier device 60 which is located upstream of the intake manifolds 50, 51; specifically, it is located between the throttles 40, 41 and intake manifolds 50, 51 such that air entering the intake manifolds is conveyed to the manifold input ports via at least one of the passageways within the airflow modifier device 60.

Airflow modifier device 60 also has input and output ports for the first and second air intake channels 18, 19, but these are combined into a single body 62 that can be molded, cast, machined, or otherwise formed. The body 62 may be formed as an integral component, such as from two or more pieces joined together, or as a unitary component made from a single, molecularly continuous piece of material. Airflow modifier device 60 has first and second air input ports 64, 65, first and second air output ports 66, 67, and first and second passageways 68, 69 respectively connecting the first air input port 64 with the first air output port 66 and the second air input port 65 with the second air output port 67. The airflow modifier device 60 further includes a central passageway 70 interconnecting the first and second passageways 68, 69 so that air entering the first and second air input ports 64, 65 can move between the first and second passageways 68, 69. Further details of the construction and operation of airflow modifier device 60 are described farther below.

In general, the airflow modifier device 60 is located between the intake air ducts 30, 31 and the intake manifolds 50, 51 such that air exiting the duct output ports is conveyed to the manifold input ports via at least one of the passageways 68-70 of the airflow modifier device. For example, this can be by air flowing through the device 60 via passageway 68 only, such that the same air entering input port 64 exits through output port 66. Alternatively, because the first and second channel passageways 68, 69 are interconnected by the cross-passageway 70, then some of the air exiting the output port 66 could come from input port 64 and some could come from input port 65 by flowing through a portion of passageway 69, then through passageway 70, to the passageway 68 where it joins the air that entered through input port 64, all of which then exits through output port 66. Or, air entering a single input port (64 or 65) may split with different portions exiting through both output ports 66, 67. These different flows may occur due to pressure differences between the passageways 68, 69 during different points in the engine cycle. Other such routing of the air through the device 60 may occur depending upon cylinder/intake plenum pressures and relative throttle positions at different points in the engine cycle. As a result, during at least some portions of the cycles of the engine 10, some of the air entering each of the manifold input ports of the first and second air intake manifolds 50, 51 comes from the airflows passing through the passageways of both the first and second throttles 40, 41.

As a result of this passageway 70, air moving through that passageway between the first and second channels 18, 19 can reduce air flow velocity fluctuations at the flow sensors 32, 33 located in the airflows upstream of the airflow modifier device 60. And, as will be appreciated by those skilled in the art, this may be done without including any flow screens in the airflow sensors 32, 33 or otherwise in the air intake channels 18, 19.

Although the airflow modifier device 60 is depicted in FIG. 1 as being located downstream of the throttles 40, 41, it may be located at another position in the airstream between the airflow sensors 32, 33 and the air intake manifolds 50, 51; for example, at a location upstream of the throttles 40, 41. Similarly, where a turbocharger or supercharger is included and installed downstream of the airflow sensors, the airflow modifier device may be included before or after the charger.

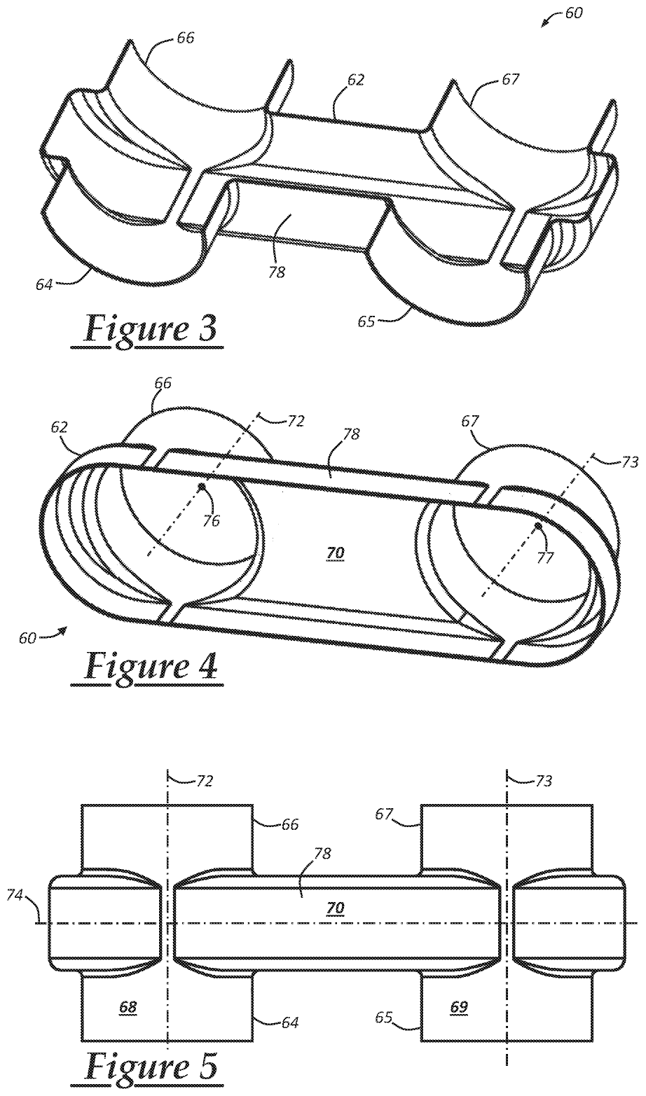

Referring now to FIGS. 2-5, the construction of the airflow modifier device 60 is shown in greater detail. The body 62 of the device may be made as a unitary component, such as from a single molded, cast, machined or 3D printed single, molecularly continuous piece of material such as plastic or metal. In other embodiments, it may be made as an integral component from multiple pieces welded or otherwise bonded together. For example, it may be made from two identical pieces each representing one half of the completed device 60 that are then welded or bonded along a seam. Examples of this include the cross-sections shown in FIGS. 3 and 4 for which two identical halves may be joined together along the section line shown.

The body 62 defines the passageways 68-70, with the first air input port 64 and first air output port 66 each comprising tubular extensions of the body 62 that are aligned with each other so as to form the first passageway 68 centered along a first flowpath line 72 extending through the airflow modifier device 60 through center points 76 of the first air input port 64 and first air output port 66, and wherein the second air input port 65 and second air output port 67 each comprise tubular extensions of the body 62 that are aligned with each other so as to form the second passageway 69 centered along a second flowpath line 73 extending through the airflow modifier device 60 through center points 77 of the second air input port 65 and second air output port 67. These flowpath lines 72, 73 may be, but need not be, linear and/or parallel, as shown in the illustrated embodiment. For example, they could be curved such as where the input ports 64, 65 enter at an angle relative to the output ports 66, 67.

The body 62 of the airflow modifier device 60 further includes a lateral plenum 78 that connects the tubular extensions defining the first passageway 68 with the tubular extensions defining the second passageway 69, the lateral plenum 78 being open into the first and second passageways 68, 69 and defining the central passageway 70 that interconnects the first and second passageways. The central passageway 70 extends along a linear third flowpath line 74 that, in the illustrated embodiment, is perpendicular to the first and second flowpath lines 72, 73.

As indicated in the figures, the passageways 68, 69 each have a cross-sectional area A that is equal to each other. For the circular input and output ports 64-67 having a common radius r, the area A is equal to π² and this can be sized to be equal to the cross-section passageway areas of the ports of one or more of the other airflow system components 30, 40, 50, or as otherwise desired or appropriate for the particular engine application.

The central passageway 70 has a cross-section area B that, for the generally rectangular cross-section shown, is equal the width w times the height h of the plenum 78. That area B may take on different sizes depending on the application, but at sizes much less than 50% of the area A the amount of velocity fluctuation smoothing is reduced and, at sizes greater than 150% there is no apparent increase in velocity fluctuation smoothing. Thus, in at least some embodiments the cross-sectional area B is at least 50% and not more than 150% of the cross-sectional area A, and in some more specific embodiments, is not more than 100% of the cross-sectional area A.

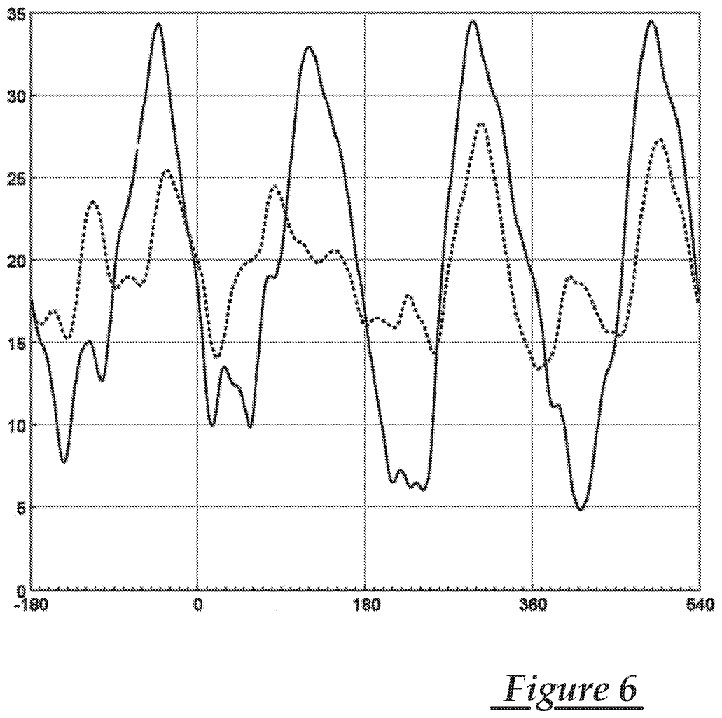

FIG. 6 depicts simulated results of a MAF sensor output, graphing crank angles of an engine cycle along the horizontal axis versus airflow velocity (in m/s) along the vertical axis. The solid line indicates an intake air system without the airflow modifier device 60, whereas the broken line indicates the reduced fluctuation signal resulting from use of the device 60. As will be appreciated by those skilled in the art, the size of the central passageway 70 (area B) can be tuned to address specific RPM/load conditions.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, although the airflow modifier device may be particularly advantageous when used with a MAF sensor, it may also be used in conjunction with other types of air flow sensors such as a manifold absolute pressure (MAP) sensor, or in systems that use both MAF and MAP sensors. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. An airflow modifier device for reducing air velocity fluctuations in a multi-throttle internal combustion engine, comprising:
first and second air input ports for receiving respective first and second airflows outputted from respective first and second throttles;
first and second air output ports for providing air from one or both of the airflows to manifold input ports of a pair of intake air manifolds; and
first and second passageways respectively connecting the first air input port with the first air output port and the second air input port with the second air output port;
wherein the airflow modifier device further includes a central passageway interconnecting the first and second passageways so that, when in use, air entering the first and second air input ports can move between the first and second passageways and can thereby reduce air flow velocity fluctuations at flow sensors located in the airflows upstream of the airflow modifier device.

2. The airflow modifier device defined in claim 1, wherein the airflow modifier device comprises an integral or unitary body that defines the passageways, wherein the first air input port and first air output port each comprise tubular extensions of the body that are aligned with each other so as to form the first passageway centered along a first flowpath line extending through the airflow modifier device through center points of the first air input port and first air output port, and wherein the second air input port and second air output port each comprise tubular extensions of the body that are aligned with each other so as to form the second passageway centered along a second flowpath line extending through the airflow modifier device through center points of the second air input port and second air output port.

3. The airflow modifier device defined in claim 2, wherein the body further comprises a lateral plenum that connects the tubular extensions defining the first passageway with the tubular extensions defining the second passageway, the lateral plenum being open into the first and second passageways and defining the central passageway that interconnects the first and second passageways.

4. The airflow modifier device defined in claim 3, wherein the first and second flowpath lines are linear and extend in a direction parallel to each other, and wherein the central passageway extends along a linear third flowpath line that is perpendicular to the first and second flowpath lines.

5. The airflow modifier device defined in claim 1, wherein the first and second passageways each have a cross-sectional area A that are equal to each other, and the central passageway has a cross-sectional area B that is at least 50% and not more than 150% of the cross-sectional area A.

6. A multi-throttle intake air system for an internal combustion engine, comprising:
first and second throttles each having a throttle input port, a throttle output port, a passageway connecting the throttle input port and throttle output port, and a throttle control member that controls the magnitude of an airflow through the passageway of its associated throttle;
first and second air intake manifolds each having a manifold input port and a plurality of manifold output ports, wherein the manifold input port of the first air intake manifold receives air exiting the throttle output port of the first throttle, and the manifold input port of the second air intake manifold receives air exiting the throttle output port of the second throttle; and
an airflow modifier device having first and second air input ports, first and second air output ports, and first and second passageways respectively connecting the first air input port with the first air output port and the second air input port with the second air output port, wherein the airflow modifier device further includes a central passageway interconnecting the first and second passageways so that air entering the first and second air input ports can move between the first and second passageways;
wherein the airflow modifier device is located upstream of the intake manifolds such that air entering the intake manifolds is conveyed to the manifold input ports via at least one of the passageways of the airflow modifier device.

7. The multi-throttle intake air system defined in claim 6, further comprising:
first and second intake air ducts each having a duct input port, a duct output port, and a passageway connecting the input port and output port, wherein the passageways of the first and second intake air ducts each conveys at least some of the airflow passing through the first and second throttles, respectively; and
first and second air flow sensors mounted at the first and second intake air ducts, respectively, wherein the first and second air flow sensors measure the airflows moving through the passageways of the respective first and second intake air ducts;
wherein the airflow modifier device is located between the intake air ducts and the intake manifolds such that air exiting the duct output ports is conveyed to the manifold input ports via at least one of the passageways of the airflow modifier device.

8. The multi-throttle intake air system defined in claim 7, wherein the airflow modifier device is located between the throttles and intake manifolds such that air exiting the throttle output ports is conveyed to the manifold input ports via at least one of the passageways of the airflow modifier device, and wherein the throttle input ports receive the airflows from the duct output ports of the first and second intake air ducts, whereby the intake air ducts and air flow sensors are positioned upstream of the throttles.

9. The multi-throttle intake air system defined in claim 6, wherein during at least some portions of cycles of the internal combustion engine, some of the air entering each of the manifold input ports of the first and second air intake manifolds comes from the airflows passing through the passageways of both the first and second throttles.

10. The multi-throttle intake air system defined in claim 6, wherein the airflow modifier device comprises an integral or unitary body that defines the passageways, wherein the first air input port and first air output port each comprise tubular extensions of the body that are aligned with each other so as to form the first passageway centered along a first flowpath line extending through the airflow modifier device through center points of the first air input port and first air output port, and wherein the second air input port and second air output port each comprise tubular extensions of the body that are aligned with each other so as to form the second passageway centered along a second flowpath line extending through the airflow modifier device through center points of the second air input port and second air output port.

11. The multi-throttle intake air system defined in claim 10, wherein the body further comprises a lateral plenum that connects the tubular extensions defining the first passageway with the tubular extensions defining the second passageway, the lateral plenum being open into the first and second passageways and defining the central passageway that interconnects the first and second passageways.

12. The multi-throttle intake air system defined in claim 11, wherein the first and second flowpath lines are linear and extend in a direction parallel to each other, and wherein the central passageway extends along a linear third flowpath line that is perpendicular to the first and second flowpath lines.

13. The multi-throttle intake air system defined in claim 6, wherein the first and second passageways each have a cross-sectional area A that are equal to each other, and the central passageway has a cross-sectional area B that is at least 50% and not more than 150% of the cross-sectional area A.

14. A multi-throttle internal combustion engine, comprising:
first and second intake air ducts each having a duct input port, a duct output port, and a passageway connecting the input port and output port, wherein the intake air ducts each receives an airflow that enters the input port and exits the output port;
first and second mass air flow sensors mounted at the first and second intake air ducts, respectively, wherein the first and second mass air flow sensors measure the amount of air moving through the passageways of the respective first and second intake air ducts;
first and second throttles each having a throttle input port that receives the airflow exiting from the output port of its associated intake air duct, wherein the first and second throttles each further have a throttle output port, a passageway connecting the throttle input port and throttle output port, and a throttle control member that controls the magnitude of the airflow through the passageway of its associated throttle;
first and second air intake manifolds each having a manifold input port and a plurality of manifold output ports, wherein the manifold input port of the first air intake manifold receives air exiting the throttle output port of the first throttle, and the manifold input port of the second air intake manifold receives air exiting the throttle output port of the second throttle;
first and second cylinder banks each having a plurality of cylinders that, in operation, provide motive power during successive cycles of the internal combustion engine, wherein each of the cylinders of the first cylinder bank are connected to receive air from one of the manifold output ports of the first air intake manifold, and each of the cylinders of the second cylinder bank are connected to receive air from one of the manifold output ports of the second air intake manifold; and
an airflow modifier device having first and second air input ports, first and second air output ports, and first and second passageways respectively connecting the first air input port with the first air output port and the second air input port with the second air output port, wherein the airflow modifier device further includes a central passageway interconnecting the first and second passageways so that air entering the first and second air input ports can move between the first and second passageways;
wherein the airflow modifier device is located between the intake air ducts and the intake manifolds such that air exiting the duct output ports is conveyed to the manifold input ports via at least one of the passageways of the airflow modifier device; and
wherein during at least some portions of the cycles of the internal combustion engine, some of the air entering each of the manifold input ports of the first and second air intake manifolds comes from the airflows passing through the passageways of both the first and second throttles.

15. The multi-throttle internal combustion engine defined in claim 14, wherein the airflow modifier device is located between the throttles and intake manifolds such that air exiting the throttle output ports is conveyed to the manifold input ports via at least one of the passageways of the airflow modifier device.

16. The multi-throttle internal combustion engine defined in claim 14, wherein the airflow modifier device comprises an integral or unitary body that defines the passageways, wherein the first air input port and first air output port each comprise tubular extensions of the body that are aligned with each other so as to form the first passageway centered along a first flowpath line extending through the airflow modifier device through center points of the first air input port and first air output port, and wherein the second air input port and second air output port each comprise tubular extensions of the body that are aligned with each other so as to form the second passageway centered along a second flowpath line extending through the airflow modifier device through center points of the second air input port and second air output port.

17. The multi-throttle internal combustion engine defined in claim 16, wherein the body further comprises a lateral plenum that connects the tubular extensions defining the first passageway with the tubular extensions defining the second passageway, the lateral plenum being open into the first and second passageways and defining the central passageway that interconnects the first and second passageways.

18. The multi-throttle internal combustion engine defined in claim 17, wherein the first and second flowpath lines are linear and extend in a direction parallel to each other, and wherein the central passageway extends along a linear third flowpath line that is perpendicular to the first and second flowpath lines.

19. The multi-throttle internal combustion engine defined in claim 14, wherein the first and second passageways each have a cross-sectional area A that are equal to each other, and the central passageway has a cross-sectional area B that is at least 50% and not more than 150% of the cross-sectional area A.
